(19) United States
(12) Patent Application Publication
(10) Pub. No.: US 2024/0042793 A1
(43) Pub. Date: Feb. 8, 2024

(54) TRANSFER FILM, USE OF A TRANSFER FILM, METHOD FOR PRODUCING A TRANSFER FILM, METHOD FOR DECORATING A PLASTIC ARTICLE, AND PLASTIC ARTICLE

(71) Applicant: LEONHARD KURZ Stiftung & Co. KG, Fürth (DE)

(72) Inventor: Jürgen SCHMIDT, Fürth (DE)

(21) Appl. No.: 18/268,363

(22) PCT Filed: Dec. 20, 2021
(86) PCT No.: PCT/EP2021/086815

§ 371 Date: Jun. 20, 2023

(30) Foreign Application Priority Data
Dec. 23, 2020 (DE) 10 2020 134 833.9
Jan. 7, 2021 (DE) 10 2021 100 143.9

(51) Int. Cl. B44C 1/17; B32B 27/08; B32B 7/12

(52) U.S. Cl. CPC B44C 1/1716; B32B 27/08; B32B 7/12; B32B 2307/7145; B32B 2307/402

(57) ABSTRACT

A transfer film (1), the use of a transfer film (1), a method for producing a transfer film (1), a method for producing a transfer film (1), a method for decorating a plastic article (10), and a plastic article (10). The transfer film (1), for application to a base body (9), here includes a carrier ply (2) and a transfer ply (3) and a first layer (4), wherein the surface of the first layer (4) can be touched by a person at least in areas after the application to the base body (9), and wherein the first layer (4) contains at least one substance with an antimicrobial action.

The invention relates to a transfer film, the use of a transfer film, a method for producing a transfer film, a method for decorating a plastic article, and a plastic article.

Plastic films are used for the surface decoration of plastic parts. Plastic parts decorated in such a way are used, for example, in automobile manufacturing for automobile interior parts such as door trims, instrument panel trims and center console covers, in the field of consumer electronics for decorative trims on televisions or in the electronics and telecommunications field for housing shells for portable devices such as mobile telephones or laptops. In the case of the surface decoration of plastic parts using IMD technology (IMD=in-mold decoration) or IML technology (IML=in-mold labeling), a plastic film is inserted into an injection mold and then back-injection molded with an injection-molding compound. Plastic parts decorated in such a way have a surface which can be touched by a person at least in areas. This means that for example persons who utilize a decorated plastic part can touch its surface at least in areas. As high demands are made on the surfaces of molded plastic parts decorated in such a way, it is known to protect these, for example through a protective varnish layer on the surface of the molded plastic parts, with respect to mechanical, physical and chemical environmental influences occurring in daily use. Further protective measures in addition to this have hitherto not been implemented in transfer films, however.

From fields in which particular requirements for sterility are made, such as for example in the case of food packaging or in the case of banknotes, it is known to subsequently provide surfaces with an antibacterially active coating. Thus, an information carrier, such as a banknote or an identity card, the surface of which is subsequently provided with a biocidal agent, is known from US 2005/0175712 A1. As an alternative to this, surfaces can be irradiated with UV radiation or treated with antibiotics (preferably in medical technology) and/or fungicides. In these methods the surface is also only subsequently antibacterially treated, for example. A disadvantage here is further that this is a one-time treatment, and thus not a permanent solution. Furthermore, it can result in the development of undesired resistance to the antibiotics. In particular, fungicides and their residues can also be harmful to human health.

The object of the invention is now to provide an improved transfer film, and an improved method for decorating a plastic article.

This object is achieved by a transfer film for application to a base body and comprising a carrier ply and a transfer ply, wherein the transfer film has a first layer the surface of which can be touched by a person at least in areas after the application to the base body, and wherein the first layer contains at least one substance with an antimicrobial action.

This object is further achieved by a method for producing a transfer film, in particular according to one of claims 1 to 18, comprising a carrier ply, a transfer ply and a first layer, wherein the surface of the first layer can be touched by a person at least in areas after the application to a base body, wherein the first layer contains at least one substance with an antimicrobial action, and wherein the method comprises the following steps, in particular which are carried out in the following order:
providing the carrier ply;
applying the first layer to the carrier ply, in particular by means of printing;
applying the transfer ply to the carrier ply and/or to the first layer, in particular by means of printing, casting, laminating or stamping.

This object is further achieved by the use of a transfer film according to one of claims 1 to 18 as a hot-stamping film and/or in-mold film, in particular as an in-mold decoration film (IMD film), insert-molding film, in-mold labeling film (IML film) and/or print mold design film.

This object is also achieved by a method for decorating a plastic article with a base body formed of a plastic injection-molding compound comprising the following steps, which are in particular performed in the following order:
providing a transfer film, in particular according to one of claims 1 to 18, comprising a carrier ply, a transfer ply and a first layer, wherein the surface of the first layer can be touched by a person at least in areas after the application to the base body and wherein the first layer contains at least one substance with an antimicrobial action;
arranging the transfer film in an injection mold;
back-injection molding the transfer film arranged in the injection mold with the plastic injection-molding compound such that the base body is formed by the plastic injection-molding compound and the base body joins to the transfer film;
optionally removing the carrier ply, in particular from the decorated plastic article;
optionally taking the decorated plastic article out of the injection mold.

This object is further also achieved by a plastic article, in particular produced according to the method according to one of claims 27 to 29, comprising a base body formed of a plastic injection-molding compound, and a first layer, wherein the first layer can be touched by a person at least in areas and contains at least one substance with an antimicrobial action.

It has been shown here that the properties of plastic articles can be improved and at the same time the production process can be simplified by the transfer film according to the invention, the use of the transfer film, the method for producing the transfer film, the method for decorating a plastic article, and the plastic article. Because the transfer film, in particular the first layer, already has an antimicrobial action, the plastic article decorated with the transfer film has a surface which can be touched in particular by a person at least in areas and which has an antimicrobial action. Persons who touch this surface are thus protected with respect to exposure to germs, in particular by microorganisms, such as for example bacteria, fungi or viruses. Further, a usual injection-molding method can for example be used to apply the transfer film, with the result that complex and expensive further processing steps, which would be generated in particular by the subsequent application of an antimicrobial layer, can be dispensed with. Furthermore, already available injection-molding devices can be used to apply the transfer film to a base body, as it is a transfer film which can be processed in the known and thus familiar manner, wherein this, however, provides the advantage of directly producing an antimicrobial action.

Compared with conventional transfer films, for one thing the protective measures are thus expanded by the additional antimicrobial action, wherein at the same time the process for producing correspondingly improved plastic articles is further simplified.

It is also conceivable to provide a transfer film, in particular an in-mold decoration film (IMD film) or an insert-molding film (insert film), wherein the transfer film has a first layer, and wherein the first layer contains at least one substance with an antimicrobial action. The transfer film preferably comprises a carrier ply and a transfer ply. It is possible here for the transfer ply to comprise the first layer and/or for the carrier ply to comprise the first layer.

The transfer film is particularly preferably an in-mold decoration film (IMD film) or an insert-molding film. It is thus preferably possible for the transfer film to be an in-mold decoration film (IMD film) or an insert-molding film. However, it is also possible for the transfer film to be a hot-stamping film and/or in-mold film, in particular an in-mold labeling film (IML film) and/or a print mold design film. It is also possible for the transfer film to be a cold-stamping film, which is in particular applied to a substrate by means of radiation-curable adhesives.

The first layer preferably forms the outermost and/or uppermost layer, in particular after the application to a base body. In other words, it is possible for the first layer to form the outside, in particular which is accessible to a person. It is thus advantageous if the surface of the first layer can be touched by a person at least in areas, in particular after the application to a base body. It is also expedient if the first layer forms the layer of the transfer film facing a person. The transfer ply is preferably formed single- or multi-layered.

By a substance with an antimicrobial action is meant substances which reduce the reproduction capability or the infectivity of microorganisms or kill and/or inactivate them.

It is further possible for a substance with an antimicrobial action to be a substance with an antibacterial (against bacteria) and/or antimycotic (against fungi and pathogenic yeasts) and/or anti-eukaryotic (against algae) and/or virucidal (against viruses) action.

It is further conceivable to provide a method for decorating an article with a base body, wherein the method comprises the following steps, which are in particular performed in the following order:
providing a transfer film according to the invention, preferably according to one of claims 1 to 18, further preferably comprising a carrier ply, a transfer ply and a first layer, wherein the surface of the first layer can be touched by a person at least in areas after the application to the base body, and wherein the first layer contains at least one substance with an antimicrobial action;
applying the transfer film to the base body, in particular such that the base body joins to the transfer film.

It is advantageous here if the step of applying the transfer film to the base body is effected or is carried out by or by means of laminating, hot stamping and/or injection molding or back-injection molding.

In the case of injection molding or back-injection molding it is further advantageous if the method further comprises at least one of the following steps:
arranging the transfer film in an injection mold;
back-injection molding the transfer film arranged in the injection mold with a plastic injection-molding compound such that the base body is formed by the plastic injection-molding compound and the base body joins to the transfer film;
optionally removing the carrier ply from the decorated article;
optionally taking the decorated article out of the injection mold.

It is also conceivable to provide an article, in particular a plastic article, wherein the article, in particular the plastic article, comprises a transfer film according to the invention, in particular according to one of claims 1 to 18. Furthermore, it is conceivable to provide an article, in particular a plastic article, wherein the article, in particular the plastic article, comprises the transfer ply and/or the carrier ply of the transfer film, in particular according to the invention, in particular wherein the first layer can be touched by a person at least in areas and contains at least one substance with an antimicrobial action.

The article is preferably a plastic article, further preferably an injection-molded article. In other words, it is possible for the article to be a plastic article, in particular an injection-molded article, and/or for the method for decorating an article to be a method for decorating a plastic article, in particular an injection-molded article.

It is further also preferred if the plastic article is an injection-molded article. It is thus possible for the plastic article to be an injection-molded article and/or for the method for decorating a plastic article to be a method for decorating an injection-molded article.

In addition to a base body made of plastic, it is further also possible for the base body to comprise paper, wood and/or metal. It is also possible for the base body to be made, for example, of paper, wood, stone, cardboard or metal. It is thus possible, for example, for the base body to be a paper, cardboard or sheet metal.

It is thus expedient if the base body comprises plastic, paper and/or metal.

It is also conceivable to provide a method for producing a transfer film, in particular according to one of claims 1 to 18, wherein the transfer film comprises a first layer, preferably wherein the transfer film further comprises a carrier ply and a transfer ply, wherein the surface of the first layer can further preferably be touched by a person at least in areas after the application to a base body, wherein the first layer contains at least one substance with an antimicrobial action, and wherein the method comprises the following steps, in particular which are carried out in the following order:
providing the carrier ply;
applying the first layer to the carrier ply, in particular wherein the transfer ply comprises the first layer;
optionally applying a decorative ply, an adhesion-promoter layer and/or a primer layer, in particular wherein the transfer ply comprises the decorative ply, the adhesion-promoter layer and/or the primer layer and/or wherein the first layer is arranged between the carrier ply and the decorative ply, the adhesion-promoter layer and/or the primer layer.

The layers or plies are preferably applied in particular by means of printing, casting, laminating or stamping.

It is further also conceivable to provide a method for producing a transfer film, in particular according to one of claims 1 to 18, wherein the transfer film comprises a first layer, preferably wherein the transfer film further comprises a carrier ply and a transfer ply, wherein the surface of the first layer can further preferably be touched by a person at least in areas after the application to a base body, wherein the first layer contains at least one substance with an antimicrobial action, and wherein the method comprises the following steps, in particular which are carried out in the following order:
providing the carrier ply;
applying the first layer to the carrier ply, in particular wherein the carrier ply comprises the first layer;
optionally applying a decorative ply, an adhesion-promoter layer and/or a primer layer, in particular wherein the transfer ply comprises the decorative ply, the adhesion-promoter layer and/or the primer layer.

The layers or plies are preferably applied in particular by means of printing, casting, laminating or stamping.

Further advantageous designs of the invention are described in the dependent claims.

It is advantageous that the transfer ply is detachable from the carrier ply. It is hereby achieved that, in particular if the first layer is part of the transfer ply and/or if the first layer is arranged between the carrier ply and transfer ply, the first layer forms the uppermost layer, in particular with the result that the first layer and/or the surface thereof can be touched by a person at least in areas after the application to the base body.

It is further preferred that the first layer is arranged between the carrier ply and the transfer ply.

It is further expedient if the transfer film comprises a detachment layer, in particular which is arranged between the carrier ply and the, in particular detachable, transfer ply.

It is thus further expedient if the method further comprises the following step, in particular which is carried out between the step of providing the carrier ply and the step of applying the transfer ply to the carrier ply:
applying a detachment layer, preferably such that the detachment layer is arranged between the carrier ply and the, in particular detachable, transfer ply.

The detachment layer preferably has a layer thickness of between 0.01 μm and 10 μm, preferably between 0.1 μm and 5 μm, and/or has components which are individually or in combination selected from: waxes, polyethylene (PE), polypropylene (PP), cellulose derivatives, poly(organo)siloxanes.

It is further preferred if, in particular after the step of back-injection molding the transfer film arranged in the injection mold with the plastic injection-molding compound, the following step is further carried out:
peeling the or a carrier ply off the transfer film.

It is further possible for the first layer to be arranged on the side of the carrier ply facing away from the transfer ply.

It is further also possible for the carrier ply to contain at least one substance with an antimicrobial action.

It is thus possible for the carrier ply to contain the first layer and/or for the transfer ply to contain the first layer. In other words, it is possible for the first layer to be comprised by the carrier ply and/or for the first layer to be comprised by transfer ply, in particular for the first layer to form a part of the carrier ply and/or for the first layer to form a part of the transfer ply.

Depending on the design and position of the first layer, it is also possible for the transfer film to be a laminating film. If, for example, the carrier ply is also transferred onto the base body or it remains on the plastic article, the transfer film is then used in the sense of a laminating film.

Furthermore, it is expedient if the first layer is applied such that the first layer is arranged between the carrier ply and the transfer ply and/or that the first layer is arranged on the carrier ply.

The carrier ply is preferably selected from the group ABS (=acrylonitrile butadiene styrene), ABS/PC, PET (=polyethylene terephthalate), PC (=polycarbonate), PMMA (=polymethyl methacrylate), PE (=polyethylene), PP (=polypropylene) and/or PPP (=polyether polycarbonate polyols). The layer thickness of the carrier ply is advantageously between 5 μm and 5000 μm, further advantageously between 6 μm and 500 μm, in particular between 10 μm and 100 μm.

It is further expedient if the carrier ply is transparent, in particular that the carrier ply has, in particular in the wavelength range between 380 nm and 780 nm, a transmittance of at least 25%, preferably of at least 35%, further preferably of at least 85%.

The at least one substance with an antimicrobial action preferably is or comprises a heavy metal, preferably silver (Ag), further preferably colloidal silver (Ag(0)) and/or bound silver (Ag⁺). In other words, it is possible for the at least one substance with an antimicrobial action to be a heavy metal, preferably silver (Ag), further preferably colloidal silver (Ag(0)) and/or bound silver (Ag⁺).

It is advantageous here that through this, as set out further below, on the one hand a very high antimicrobial action is produced and on the other hand a good processing of the transfer film is guaranteed. Further, such a transfer film is substantially free from harmful side effects for the user and is also characterized by a high environmental compatibility. In other words, effects that are harmful to human health can hereby be reduced and/or prevented, in particular in the case of proper use.

Colloidal silver is preferably ultrafine particles of elemental silver (nanosilver) or else of low-solubility silver compounds and/or liquid dispersions thereof.

The particle size of colloidal silver is advantageously between 1 nm and 100 nm, in particular the particle size of colloidal silver is less than 20 nm. It is also possible, for example, for the particle size of colloidal silver to be 8 nm for approx. ⅓ of the particles and 18 nm for approx. ⅔ of the particles. Approximately from 1000 to 1,000,000,000 silver atoms or molecules of the corresponding silver compound are further preferably contained in the individual particles.

Colloidal silver is preferably produced by reduction of silver ions in solution in the presence of stabilizers, e.g. polyethylene glycol (PEG). It is thus possible for the colloidal silver to be “dissolved” in a solution, in particular wherein the solution contains complexing agents (stabilizers) and solvents. It is preferred here that the complexing agents are the solvent at the same time. For example, such complexing agents, which are the solvent at the same time, are polysorbate and PEG.

Bound silver is advantageously produced by applying a silver solution to a carrier material, wherein the carrier material binds the silver ions to its surface, in particular with the result that bound silver is formed.

Bound silver preferably is or comprises Ag₂O—Ca_{α}Zn_{β}Al_{γ}(PO₄)₆. In other words, it is possible for bound silver to be Ag₂O—Ca_{α}Zn_{β}Al_{γ}(PO₄)₆.

It is thus possible for the method to further comprise the following step, in particular which is carried out before the step of applying the first layer to the transfer ply and/or carrier ply:
mixing the at least one substance with an antimicrobial action into the starting material of the first layer, in particular wherein the at least one substance with an antimicrobial action is present in solution.

The method preferably further comprises the following step, in particular which is carried out before the step of applying the first layer to the transfer ply and/or carrier ply:
comminuting and/or dispersing the at least one substance with an antimicrobial action, in particular by means of mills, e.g. by means of basket mills.

The antimicrobial mode of action of colloidal silver (Ag(0)) and/or bound silver (Ag⁺) is illustrated below with reference to the example of silver oxide (AgO₂). In order to be able to develop the activity, free silver ions (Ag⁺) must first be formed. This usually works via the presence of moisture and/or water. With reference to the example of silver oxide (AgO₂) the following then applies: AgO₂+H₂O→2Ag⁺+2OH⁻, with the result that the required silver ions (Ag⁺) are present.

The silver ions (Ag⁺) in particular formed in such a way kill or inactivate bacteria, for example, as follows:
silver ions (Ag⁺) bind in particular to hydrogen sulfide groups (SH groups) of the enzyme system, with the result that energy metabolism and electron transport are inactivated. The lack of electrolyte and liquid resulting from this leads to the dehydration of the bacteria.
silver ions (Ag⁺) bind in particular to enzyme systems which are responsible for the respiratory chain, with the result that the enzyme system is blocked.
silver ions (Ag⁺) bind to the DNA, with the result that replication is inhibited.

The at least one substance with an antimicrobial action less preferably is or comprises copper (Cu/Cu²⁺) and/or mercury (Hg/Hg²⁺). Mercury (Hg/Hg²⁺), in particular, is hardly suitable for humans due to its toxicity. The antimicrobial action is in particular brought about by the respective metal ion (Cu²⁺, Hg²⁺, Ag⁺).

Furthermore, it is conceivable that the at least one substance with an antimicrobial action is or comprises an antibiotic, such as for example docycline or teicolanin, and/or is or comprises a fungicide, such as for example triclosan.

The percentage of the at least one substance with an antimicrobial action in the first layer is preferably between 0.01% and 10%, preferably between 0.1% and 5%, further preferably between 1% and 2%. These values preferably relate to the solids (FSK), i.e. to the dried and/or partially dried first layer and not to the liquid starting material of the first layer. It is thus possible for the percentage of the at least one substance with an antimicrobial action in the first layer to be between 0.01% and 10%, preferably between 0.1% and 5%, further preferably between 1% and 2%, in the solids (FSK).

It is further possible for at least one first area of the first layer to contain at least one first substance with an antimicrobial action and for at least one second area of the first layer to contain at least one second substance with an antimicrobial action, in particular wherein the at least one first substance with an antimicrobial action is or comprises colloidal silver (Ag(0)) and the at least one second substance with an antimicrobial action is or comprises bound silver (Ag⁺). However, it is also possible, for example, for the at least one first substance with an antimicrobial action to be or comprise for example copper (Cu) and for the at least one second substance with an antimicrobial action to be or comprise for example silver (Ag).

By area is meant here in each case a defined surface area of a layer or ply, which is occupied when viewed perpendicular to a plane spanned by the transfer film. Thus, for example, the transfer film has one or more areas, wherein each of the areas in each case occupies a defined surface area when viewed perpendicular to a plane spanned by the transfer film.

It further advantageous that, through the at least one substance with an antimicrobial action, a mean log reduction R, in particular relative to a reference sample after 24 h, preferably in accordance with the standard ISO 22196 (ISO 22196:2011(E), “Measurement of antibacterial activity on plastics and other non-porous surfaces”, second edition, issue date: 2011 Aug. 1), of at least 4, preferably of at least 5, further preferably between 4 and 8, still further preferably between 5 and 7, is achieved and/or that, through the at least one substance with an antimicrobial action, a mean log reduction R₀, in particular relative to a reference sample at the time 0, preferably in accordance with the standard ISO 22196, of at least 4, preferably of at least 6, further preferably between 4 and 7, is achieved.

A particularly good antimicrobial and/or antibacterial activity can hereby be demonstrated.

The antimicrobial and/or antibacterial activity is preferably determined in accordance with the standard ISO 22196, in particular on the basis of the mean log reduction R and/or R₀. R is calculated here as follows:

R=Uₜ−Aₜ,

wherein R is the mean log reduction relative to a reference sample after 24 h, Uₜ is the logarithm of the averaged number of viable bacteria per cm², in the untreated test samples after 24 h, and Aₜ is the logarithm of the averaged number of viable bacteria per cm², in the test samples with antimicrobial and/or antibacterial properties.

R₀ is the mean log reduction in relation to the average number of viable bacteria at the time 0 (initial concentration). In other words, R₀ is the mean log reduction relative to a reference sample at the time 0. As hardly any or no proliferation of the cells takes place in the case of a high antimicrobial and/or antibacterial activity, it may make sense in particular to determine the mean log reduction in relation to the initial concentration.

The values Uₜ and Aₜ are given in the unit CFU/cm² here. Single or several connected individual microorganisms, which preferably form a colony through proliferation in or on a gel nutrient medium, are in particular referred to as a colony-forming unit (CFU) per cm².

It is further preferred if the first layer has not yet been or is not yet completely cured at least in areas.

It is also possible if the method for decorating an article, in particular a plastic article, further comprises the following step, in particular which is carried out after the step of back-injection molding the transfer film arranged in the injection mold with the plastic injection-molding compound:
curing, in particular completely curing, the first layer, in particular by means of UV radiation.

It is thus possible if the first layer has not been and/or is not completely cured until after the application to the base body. It is further possible if the first layer has been and/or is completely cured after the step of back-injection molding the transfer film arranged in the injection mold with the plastic injection-molding compound.

It is also expedient that the first layer is radiation-curable, in particular UV-curable, and/or that the first layer is thermally curable and/or chemically crosslinkable.

It is thus possible for the first layer to be UV-curable and/or UV-crosslinkable, in particular by means of UV radiation from the wavelength range between 100 nm and 380 nm, preferably between 200 nm and 380 nm, further preferably between 200 nm and 300 nm, and/or for the first layer to be thermally curable and/or chemically crosslinkable. It is expedient here if the curing of the first layer is effected by means of UV radiation, in particular in the coating machine for applying the first layer. It is further also possible for the first layer to be curable by means of electron radiation. The curing of the first layer can alternatively or additionally be effected by means of high-energy radiation such as UV radiation or electron radiation in one or more downstream method steps, which can follow the application directly and/or can also follow it delayed in time.

It is also possible for the first layer to be precurable chemically, thermally or by means of radiation, in particular by means of UV radiation, and, preferably after the application to the base body, to be completely curable chemically thermally or by means of radiation, in particular by means of UV radiation.

In particular before the complete curing, the first layer not yet completely cured at least in areas is still relatively flexible and the transfer film as a whole can thus advantageously be easily processed. However, the resistance to the action of chemicals is in particular not yet provided. In particular, the at least one completely cured first layer then formed of the first layer not yet completely cured at least in areas, e.g. as a protective varnish layer, does not exhibit the desired properties such as particular surface hardness, resistance to suncream constituents, DEET (e.g. Autan©) and/or solvents, as well as at the same time the desired antimicrobial action, until after the curing, e.g. by means of UV radiation.

The first layer, in particular if it is precurable chemically, thermally or by means of radiation, in particular by means of UV radiation, preferably contains colloidal silver (Ag(0)) as the at least one substance with an antimicrobial action. In other words, a so-called “precure (transfer) film” preferably contains colloidal silver (Ag(0)) as the at least one substance with an antimicrobial action. It is further preferred if the first layer, in particular if it is completely curable chemically, thermally or by means of radiation, in particular by means of UV radiation, contains bound silver (Ag⁺) as the at least one substance with an antimicrobial action. In other words, a so-called “postcure (transfer) film” preferably contains bound silver (Ag⁺) as the at least one substance with an antimicrobial action. It is also further possible for a thermoplastic transfer film, in particular a thermoplastic in-mold decoration film (IMD film), and/or a chemically crosslinkable transfer film, in particular a chemically crosslinkable in-mold decoration film (IMD film), i.e. in particular transfer films which do not require UV curing, to contain colloidal silver (Ag(0)) as the at least one substance with an antimicrobial action.

The first layer is advantageously a protective varnish layer, in particular which has a layer thickness of between 1 μm and 15 μm, preferably between 2 μm and 8 μm, and/or which contains isocyanate groups having hydroxyl groups, melamine resins having hydroxyl groups, polyisocyanates having hydroxyl-containing polymers or melamine resins having hydroxyl-containing polymers.

It is further advantageous that the first layer is applied with an application weight of between 1 g/m² and 20 g/m², preferably between 2 g/m² and 15 g/m², preferably between 2 g/m² and 15 g/m², further preferably between 3 g/m² and 10 g/m², still further preferably between 4 g/m² and 8 g/m².

Polyisocyanates preferably comprise components which comprise at least two isocyanate groups, in particular wherein the isocyanate groups are at least one group selected from diisocyanate monomer, diisocyanate oligomer, diisocyanate-terminated prepolymer, diisocyanate-terminated polymer, polyisocyanate monomer, polyisocyanate oligomer, polyisocyanate-terminated prepolymer, and/or polyisocyanate-terminated polymer, and/or mixtures thereof. It is further possible here for the diisocyanate-comprising component to comprise at least one polyurethane or polyurea oligomer, prepolymer, polymer, or mixtures thereof. The term “polyisocyanate” is preferably used in order to substantially denote components having more than two isocyanate groups, including triisocyanates and higher-functionalized isocyanates.

The components which comprises at least two isocyanate groups further preferably comprise at least one group of a hexamethylene diisocyanate (HDI), isophorone diisocyanate (IPDI), methylene diphenyl diisocyanate (MDI), toluene diisocyanate (TDI), phenylene diisocyanate, naphthalene diisocyanate (NDI), diphenyl sulfone diisocyanate, ethylene diisocyanate, propylene diisocyanate, dimer of these diisocyanates, trimer of these diisocyanates, triphenylmethane triisocyanate, polyphenylmethane polyisocyanate (polymerized MDI), or mixtures thereof.

The hydroxyl groups preferably comprise, in particular, hydroxyl-functional acrylic components, at least one hydroxy monoacrylate, one hydroxy diacrylate, one hydroxy polyacrylate, one hydroxyl-functional aliphatic polyether urethane monoacrylate, one hydroxyl-functional aliphatic polyester urethane monoacrylate, one hydroxyl-functional aromatic polyether urethane monoacrylate, one hydroxyl-functional aromatic polyester urethane monoacrylate, one hydroxyl-functional polyester monoacrylate, one hydroxyl-functional polyether monoacrylate, one hydroxyl-functional epoxy monoacrylates, one hydroxyl-functional acrylated acrylic monoacrylate, one hydroxyl-functional aliphatic polyether urethane diacrylate, one hydroxyl-functional aliphatic polyester urethane diacrylate, one hydroxyl-functional aromatic polyether urethane diacrylate, one hydroxyl-functional aromatic polyester urethane diacrylate, one hydroxyl-functional polyester diacrylate, one hydroxyl-functional polyether diacrylate, one hydroxyl-functional epoxy diacrylate, one acrylated acrylic diacrylate, one hydroxyl-functional aliphatic polyether urethane polyacrylate, one hydroxyl-functional aliphatic polyester urethane polyacrylates, one hydroxyl-functional aromatic polyether urethane polyacrylate, one hydroxyl-functional aromatic polyester urethane polyacrylate, one hydroxyl-functional polyester polyacrylate, one hydroxyl-functional polyether polyacrylate, one hydroxyl-functional epoxy polyacrylate, one hydroxyl-functional acrylated acrylic polyacrylate, or mixtures thereof.

Melamine resins preferably comprise resins which are obtained by reacting melamine with aldehydes, in particular formaldehyde, acetaldehyde, isobutyraldehyde and glyoxal. It is further possible for such resins to be partially or completely modified, for example by etherification of the methylol groups obtained with mono- or polyhydric alcohols. In other words, as melamine resins, in particular, those which can be obtained by reacting melamine with aldehydes and optionally can be partially or completely modified are suitable. In particular, formaldehyde, acetaldehyde, isobutyraldehyde and glyoxal are suitable as aldehydes. Melamine formaldehyde resins are preferably reaction products of the reaction of melamine with aldehydes, e.g. the above-named aldehydes, in particular formaldehyde. The methylol groups obtained are optionally preferably modified by etherification with mono- or polyhydric alcohols.

It is further also advantageous that the first layer comprises mixtures of UV-curable monomers and/or oligomers, individually or in combination selected from the group polyurethanes, polyacrylates, polymethacrylates, polyester resins, polycarbonates, phenolic resins, epoxy resins, polyureas, and/or melamine resins, in particular further preferably selected from the group polymethyl methacrylate (PMMA), polyester, polycarbonate (PC), polyvinylidene fluoride (PVDF).

Polyvinylidene fluoride (PVDF) is in particular a fluoroplastic, preferably produced from hydrogen fluoride and methyl chloroform, preferably wherein polyvinylidene fluoride has particularly good thermal and chemical resistance, as well as mechanical strength with at the same time high elasticity. Polyvinylidene fluoride is advantageously also chemically very inert (does not react with anything) and is very vapor- and moisture-repellent (is unaffected by anything).

Preferably, the protective varnish layer is formed transparent and/or has, in particular in the wavelength range between 380 nm and 780 nm, a transmittance of at least 25%, preferably of at least 35%, further preferably of at least 85%.

Furthermore, it is possible for the protective varnish layer to be dyed, in particular for the protective varnish layer to be dyed by means of dye pigments, and/or for the pigmentation level of the protective varnish layer to be less than 15%, preferably less than 10%, further preferably less than 5%. It is also possible for the protective varnish layer to be colorless and/or for the pigmentation level of the protective varnish layer to be 0%. It is thus possible for the protective varnish layer to be and/or to form an in particular unpigmented clear varnish layer.

It is preferred if the transfer ply has a decorative ply, in particular wherein the decorative ply has one or more, preferably opaque, translucent or transparent layers and/or colored varnish layers and/or replication varnish layers and/or metal layers.

It is useful here if the decorative ply is single- or multi-ply. It is thus possible, for example, for the decorative ply to comprise one or more colored varnish layers, which are molded such that they form a decorative colored pattern or element when they interact.

It is also advantageous if at least one colored varnish layer of the one or more colored varnish layers of the decorative ply provides a background color.

It is further possible for the decorative ply to be molded over the whole surface or in a pattern, for example in the form of alphanumeric characters, patterns, symbols or motifs. It is further expedient if the decorative ply has further optically variable layers, for example with pigments, holograms, optical diffraction structures, lenses, prisms, thin-film layers or crosslinked liquid crystals. It is thus advantageous if the decorative ply has at least one layer with a decorative effect.

The layers of the decorative ply, in particular patterned elements contained therein, can in particular also be in register relative to each other with their different optical and/or functional properties, in particular with respect to reflection, absorption and/or refractive index.

By register or registration, and/or register accuracy or registration accuracy, is meant a positional accuracy of two or more elements and/or layers relative to each other.

The register accuracy is to range within a predefined tolerance which is to be as small as possible. At the same time, the register accuracy of several elements and/or layers relative to each other is an important feature in order to increase the process reliability. The positionally accurate positioning can be effected in particular by means of sensory, preferably optically detectable registration marks or register marks. These registration marks or register marks can either represent specific separate elements or areas or layers or themselves be part of the elements or areas or layers to be positioned.

The layer thickness of the decorative ply is preferably between 0.5 μm and 100 μm, further preferably between 1 μm and 50 μm.

It is further preferred if, through the at least one substance with an antimicrobial action in the first layer, a color deviation ΔE of less than 3.0, preferably less than 1.0, further preferably less than 0.5, still further preferably less than 0.15, is produced. It is also possible if, through the at least one substance with an antimicrobial action in the first layer, a color deviation ΔE of less than 1.0, preferably less than 0.5, further preferably less than 0.2, still further preferably less than 0.15, is produced.

The color deviation ΔE preferably relates to a color impression of the transfer film and/or the first layer, in particular compared with a transfer film and/or the first layer without the at least one substance with an antimicrobial action in the first layer, wherein the transfer films are further preferably otherwise formed identical.

The color deviation ΔE is a measure of the perceived color distance between two color coordinates p=(Lₚ, aₚ, bₚ) and v=(Lᵥ, aᵥ, bᵥ) and is dependent on the application weight of the first layer, in particular the protective varnish layer, and/or the substance with an antimicrobial action in the first layer. Here, in particular, L_{p,v} is the lightness, a_{p,v} is the color value on the red-green axis and b_{p,v} is the color value on the yellow-blue axis of the two color coordinates. The color deviation ΔEₚᵥ between two color coordinates is in particular calculated as follows:

ΔEₚᵥ=\sqrt{(Lₚ−Lᵥ)²+(aₚ−aᵥ)²+(bₚ−bᵥ)²},

wherein the color coordinate with the subscript v preferably corresponds to a transfer film with the at least one substance with an antimicrobial action in the first layer and the color coordinate with the subscript p corresponds to a transfer film without the at least one substance with an antimicrobial action in the first layer, wherein the transfer films are further preferably otherwise formed identical. In particular, a color deviation is perceptible to the human eye here at the earliest from ΔE=1.0.

Measurements have shown that, in particular if the first layer, preferably the protective varnish layer, contains bound silver (Ag⁺) as the at least one substance with an antimicrobial action, with application weights of between 4 g/m² and 8 g/m² a small color deviation of ΔE of less than 3.0, preferably less than 1.0, further preferably less than 0.5, still further preferably less than 0.15, is produced. In particular, through colloidal silver (Ag(0)), on the other hand, with the same application weights a greater color deviation ΔE is produced.

It further makes sense if the decorative ply is designed such that a color deviation ΔE of the optical impression of the transfer film and/or the first layer brought about by the at least one substance with an antimicrobial action in the first layer is compensated for, preferably by variation of the decorative ply, further preferably of the one or more, preferably opaque, translucent or transparent, colored varnish layers of the decorative ply.

It thus also makes sense that the method further comprises the following step:
adapting a decorative ply such that the color deviation ΔE of the optical impression of the transfer film and/or the first layer brought about by the at least one substance with an antimicrobial action in the first layer is compensated for, preferably by variation of the decorative ply, further preferably of the one or more, preferably opaque, translucent or transparent, colored varnish layers of the decorative ply.

It is preferred here that, during the compensation for the color deviation ΔE of the optical impression of the transfer film and/or the first layer brought about by the at least one substance with an antimicrobial action in the first layer, one or more of the following parameters of the decorative ply, in particular of the one or more, preferably opaque, translucent or transparent, colored varnish layers, replication varnish layers and/or metal layers of the decorative ply, are varied: layer thickness, pigmentation level, degree of color saturation, material composition, dispersion of the pigments (depending on the fineness of grinding of the pigments), type of dispersing additives, pigment composition, pigment mixture, pigment layer thickness, metal layer thickness, metal type.

It is thus preferred that the one or more parameters are varied between 0% and 50%, preferably between 2% and 30%, compared with parameters of a transfer film without the at least one substance with an antimicrobial action in the first layer, in particular which achieves the desired optical impression for the person.

It is hereby possible, for example, to compensate for a color deviation ΔE produced through the use of colloidal silver (Ag(0)) as the at least one substance with an antimicrobial action, with the result that use can be made of the advantages of colloidal silver (Ag(0)), in particular with respect to the haze, without having to accept a color deviation ΔE.

It is advantageous if the step of applying the transfer ply further comprises at least one of the following steps:
applying a decorative ply, in particular wherein the decorative ply has one or more, preferably opaque, translucent or transparent, colored varnish layers, replication varnish layers and/or metal layers;
applying an adhesion-promoter layer, in particular such that the adhesion-promoter layer is arranged between the first layer and the decorative ply;
applying a primer layer, in particular such that the primer layer forms the side of the transfer film facing away from the person.

According to a further embodiment example of the invention, the article, in particular the plastic article, further has at least one of the following layers:
a decorative ply, wherein the decorative ply preferably has one or more, preferably opaque, translucent or transparent, colored varnish layers, replication varnish layers and/or metal layers and wherein the decorative ply is further preferably arranged between the first layer and the base body;
a primer layer, in particular wherein the primer layer is arranged between the first layer and the base body and/or between the decorative ply and the base body;
an adhesion-promoter layer, in particular wherein the adhesion-promoter layer is arranged between the first layer and the decorative ply and/or wherein the adhesion-promoter layer can preferably be arranged within the transfer ply in the form of an intermediate layer;
a, preferably detachable, carrier ply, in particular wherein the carrier ply is arranged on the side of the first layer facing away from the base body or wherein the carrier ply is arranged between the first layer and the base body.

It is furthermore advantageous that the transfer ply has a primer layer, in particular wherein the primer layer forms the side of the transfer film facing away from the person.

It is thus expedient if the primer layer is arranged on the side of the transfer ply facing away from the carrier ply.

It further makes sense if the primer layer contains polymers and/or copolymers, in particular individually or in combination selected from: acrylates (such as for example PMMA), polyester, PU, PVC.

The primer layer expediently has a layer thickness of between 0.1 μm and 50 μm, preferably between 0.5 μm and 7 μm, further preferably between 2.5 μm and 3.0 μm.

It is further possible for the transfer ply to have an adhesion-promoter layer, in particular wherein the adhesion-promoter layer is arranged between the first layer and the decorative ply.

The adhesion-promoter layer preferably has a layer thickness of between 0.1 μm and 100 μm, preferably between 0.5 μm and 50 μm, further preferably between 1 μm and 20 μm.

It is advantageous here if the adhesion-promoter layer contains components, in particular individually or in combination selected from: PMMA, PVC, polyester, polyurethanes, acrylates, chlorinated polyolefins, polypropylene, epoxy resins, polyurethane polyols, inorganic fillers. These components can be used crosslinked and/or uncrosslinked, wherein isocyanates, melamines, alcohols and aziridines can preferably be used as crosslinker component.

It is also conceivable that the transfer film further has an overprint varnish, in particular partial overprint varnish, in particular which is arranged on the first layer, preferably the side facing the person, and wherein the carrier ply has further preferably already been peeled off.

The overprint varnish is advantageously a printed layer, in particular which is designed patterned for the molding of alphanumeric characters, patterns and/or symbols. It is thus possible for the overprint varnish layer to be formed in areas. The patterned overprint varnish can in particular be arranged in register relative to further patterned elements of the decorative ply.

It is also further possible for the method for decorating an article, in particular a plastic article, to further comprise the following step, in particular which is carried out after the step of back-injection molding the transfer film arranged in the injection mold with the plastic injection-molding compound:
applying a further layer to the decorated injection-molded article, in particular by means of digital printing and/or pad printing.

It is thus possible, for example, to apply an individualization, such as for example a symbol, a pattern and/or alphanumeric characters, to the decorated article, in particular plastic article, in particular to the first layer. In addition to the application of the further layer by means of digital printing, yet further methods, such as for example hot stamping, cold stamping, pad printing or varnishing, are also conceivable. The digital print and/or hot-stamped elements and/or cold-stamped elements and/or varnished elements can in particular be arranged in register relative to further patterned elements of the decorative ply and/or in register relative to the patterned overprint varnish.

Patterned and/or alphanumeric elements of the decorative ply in combination with the overprint varnish and/or in combination with the digital print can together form a complementary item of information and/or complementary further patterned elements, which are in particular arranged in register relative to each other.

The decorative ply, the adhesion-promoter layer, the first layer, the protective varnish layer, and/or the primer layer preferably form the transfer ply of the transfer film. In other words, it is possible for the decorative ply, the adhesion-promoter layer, the first layer, the protective varnish layer, and/or the primer layer in each case to be a sublayer of the transfer ply.

According to a further embodiment example of the invention, the transfer film or the first layer scatters transmitted light, in particular light in the wavelength range between 380 nm and 780 nm, diffusely, and/or the transfer film or the first layer has a haze value of at most 30, preferably of at most 20, still further preferably of at most 15, furthermore still further preferably of at most 12.

In particular in the case that the at least one substance with an antimicrobial action is or comprises colloidal silver (Ag(0)), the first layer has an optically clear appearance. In particular in the case that the at least one substance with an antimicrobial action the at least one substance with an antimicrobial action is or comprises bound silver (Ag⁺), the first layer has an optically milky-cloudy appearance.

By optically clear is preferably meant here that the first layer deflects transmitted light, in particular light in the wavelength range between 380 nm and 780 nm, by less than 8%, preferably by less than 4%, by scattering. By optically milky-cloudy is preferably meant here that the first layer deflects more than 30%, preferably more than 45%, further preferably more than 65%, of the transmitted light, in particular from the wavelength range between 380 nm and 780 nm, by more than 2.5° from the direction of the incident light beam.

In particular in the case that the at least one substance with an antimicrobial action is or comprises colloidal silver (Ag(0)), it is thus possible for transfer film and/or the first layer to have a haze value of between 5 and 25, preferably between 10 and 20, further preferably between 10 and 15.

In particular in the case that the at least one substance with an antimicrobial action is or comprises bound silver (Ag⁺), it is thus possible for transfer film and/or the first layer to have a haze value of between 20 and 40, preferably between 20 and 30, further preferably between 25 and 30.

The haze value is preferably determined in haze units according to the ASTM D1003 standard (ASTM D1003-13, “Standard Test Method for Haze and Luminous Transmittance of Transparent Plastics”, issue date: 2013). A distinction is advantageously made here between gloss measurement and haze measurement. For example, the haze value is measured with the “BYK haze-gard i” meter from Byk-Gardener, Geretsried, Germany. In the case of the gloss measurement, a precisely defined directed light beam is directed, in particular at a 20° angle, onto a varnish surface and/or the transfer film or the first layer and a reflectometer lying opposite measures how much light is reflected at a 20° angle (grazing angle). In the case of the haze measurement, a precisely defined directed light beam is directed, in particular at a 20° angle, onto a varnish surface and/or the transfer film or the first layer and a reflectometer lying opposite measures the diffuse scattered light fraction which lies in the range between 1° and 3° adjacent to the grazing angle (20° angle). The gloss is advantageously calibrated to 100 GU (gloss units) (=100%) by a standard. The highest achievable gloss is thus preferably 100 GU. The haze is also advantageously calibrated to 100 HU (haze units) (=100%) by a standard. The highest achievable haze is thus 100 HU. The haze value and/or the gloss value is advantageously given in percent (%). It is therefore expedient if the unit of the haze value and/or the gloss value is percent (%) in this case. The value range of the haze value and/or the gloss value is therefore preferably 0-100%. The haze units and/or the gloss units are thus advantageously percentage values and/or the haze units and/or the gloss units advantageously represent percentage values. The relationship that the higher the gloss, the lower the haze and the higher the haze, the lower the gloss in particular tends to apply. Ideally, it thus preferably applies that GU and HU together gives 100 units and/or percent.

By haze is therefore preferably meant here a diffuse scattering which in particular causes a reduction in the contrast and/or an optically milky-cloudy appearance, wherein this effect is preferably called haze or cloudiness. Thus, the haze value preferably represents a measure of the cloudiness of samples, for example of plastic layers or films.

It is particularly advantageous if the transfer film is formable, in particular formable by means of injection molding and/or deep drawing. It is thus advantageously possible for the transfer film to be formed during the step of back-injection molding the transfer film arranged in the injection mold with the plastic injection-molding compound. In other words, it is preferred if the transfer film is thermoformable, in particular thermoformable by means of injection molding and/or by means of deep drawing and/or by means of high pressure forming.

It is thus advantageous if the transfer film is formable, in particular wherein the forming is effected by means of a forming technique selected from group: injection molding, forming, deep drawing, high pressure forming.

A transfer film is hereby provided, which can be easily processed in particular by means of injection molding and makes a flexible design of an injection-molded article possible.

The transfer film expediently does not differ in terms of its physical, chemical and/or haptic properties from a transfer film without the at least one substance with an antimicrobial action in the first layer, which otherwise, however, is in particular identical, except for the fact that the transfer film described here further has an antimicrobial action. In particular, the transfer film can be processed in the same manner as, for example, a transfer film without the at least one substance with an antimicrobial action in the first layer. Furthermore, the transfer film preferably has the same resistance and the same haptic properties as, for example, a transfer film without the at least one substance with an antimicrobial action in the first layer.

It is thus advantageous if the transfer film has an adhesion which has a characteristic value of GT 0 and/or 5B, preferably determined according to DIN EN ISO 2409:2013-06 (“Beschichtungsstoffe—Gitterschnittprüfung [Paints and varnishes—Cross-cut test] (ISO 2409:2013), German version of EN ISO 2409:2013”, issue date: 2013 June) and/or according to ASTM D3359-09 (“Standard Test Methods for Measuring Adhesion by Tape Test”, issue date: 2009), test method B.

In particular, the adhesion of transfer films is an important property with respect to the usability thereof.

The adhesion of the transfer film can preferably be determined with a cross-cut test according to DIN EN ISO 2409:2013-06 (“Beschichtungsstoffe—Gitterschnittprüfung [Paints and varnishes—Cross-cut test] (ISO 2409:2013), German version of EN ISO 2409:2013”, issue date: 2013 June).

The evaluation is likewise effected in particular in accordance with DIN EN ISO 2409:2013-06 by visual assessment of the measurement area and classification into cross-cut characteristic values of from κ (very good adhesion) to 5 (very poor adhesion), abbreviated to GT 0 to GT 5.

Further, an evaluation in accordance with ASTM D3359-09 (“Standard Test Methods for Measuring Adhesion by Tape Test”, issue date: 2009), test method B, is in particular also possible, wherein the characteristic values are classified from 5B (very good adhesion) to 0B (very poor adhesion).

In the case of transfer film according to the invention, cross-cut characteristic values of GT 0 and/or 5B preferably result.

It is further preferred if the first layer, in particular the protective varnish layer, further protects in particular the layers lying underneath the first layer, in particular the protective varnish layer, seen from the viewpoint of a person, from mechanical, physical and/or chemical environmental influences. In other words, it is expedient if the transfer film is resistant to mechanical, physical and/or chemical environmental influences.

These properties can be tested for example by means of a wash liquor test, preferably wherein the resistance to a wash liquor is tested at 70° C., an abrasion test, preferably by means of the “Taber abrasion test”, and/or by means of a resistance to chemicals, in particular wherein the transfer film does not differ in terms of its physical, chemical and/or haptic properties from a transfer film without the at least one substance with an antimicrobial action in the first layer, which otherwise, however, is in particular identical.

Further preferred designs of the article, in particular the plastic article, are in particular described, among other things, in the following:

It is possible for the article, in particular the plastic article, to have the following layer structure, in particular wherein the first-named layer forms the side facing the person:
carrier ply, in particular which is detachable from the transfer ply;
optionally detachment layer;
first layer, which can be touched by a person at least in areas and contains at least one substance with an antimicrobial action;
optionally adhesion-promoter layer, decorative ply, and/or primer layer;
base body, in particular base body formed of a plastic injection-molding compound.

It is also possible for the article, in particular the plastic article, to have the following layer structure, in particular wherein the first-named layer forms the side facing the person:
first layer, which can be touched by a person at least in areas and contains at least one substance with an antimicrobial action;
carrier ply;
optionally adhesion-promoter layer, decorative ply, and/or primer layer;
base body, in particular base body formed of a plastic injection-molding compound.

The features, effects and advantages described in connection with the transfer film can analogously also be assigned to the use of a transfer film, the method for producing a transfer film, the method for decorating an article or plastic article, as well as the article or plastic article and are thus also deemed to be disclosed. The same applies in reverse: features, effects and advantages which are described in connection with the methods, the use or the article or plastic article can also be assigned to the transfer film and are also deemed to be disclosed.

Embodiment examples of the invention are explained below by way of example with the aid of the accompanying figures, which are not true to scale.

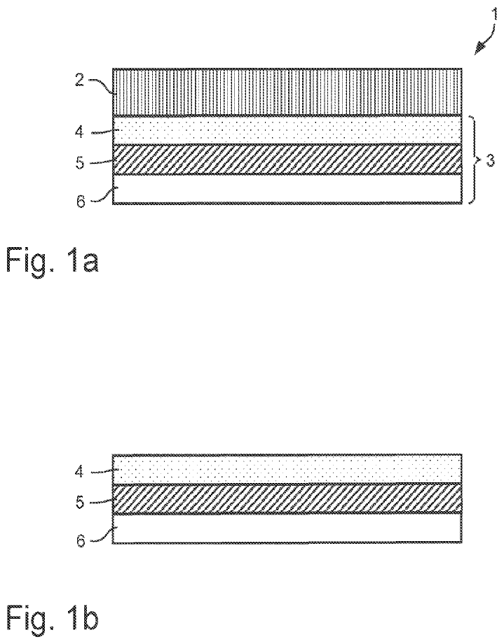

FIG. 1a and FIG. 1b schematically show sectional representations of a transfer film

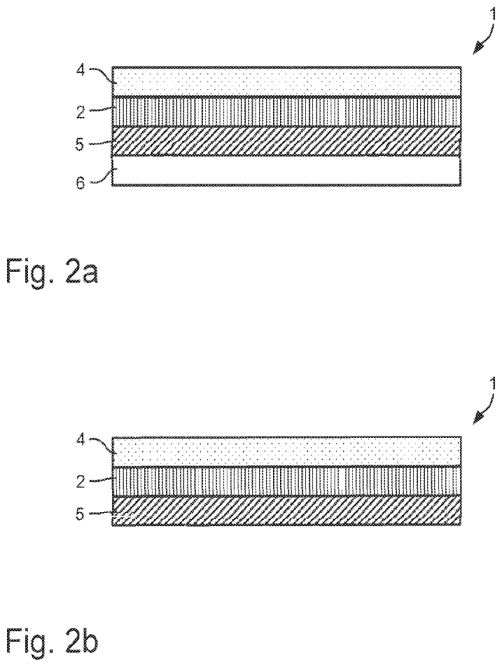

FIG. 2a and FIG. 2b schematically show sectional representations of transfer films

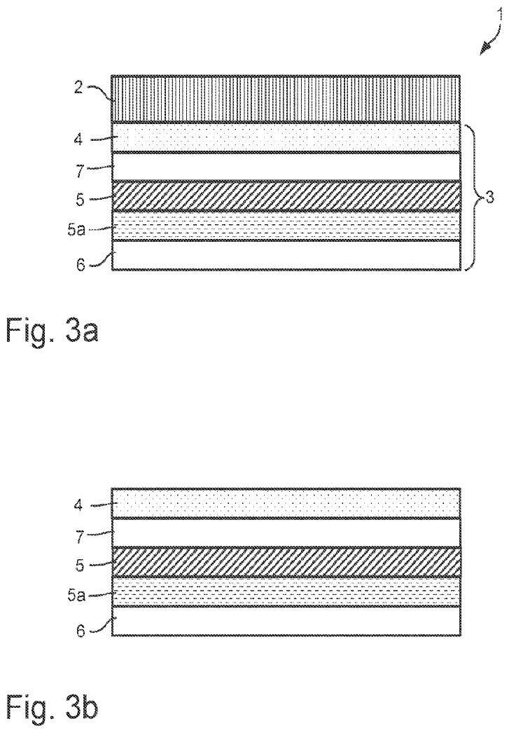

FIG. 3a and FIG. 3b schematically show sectional representations of a transfer film

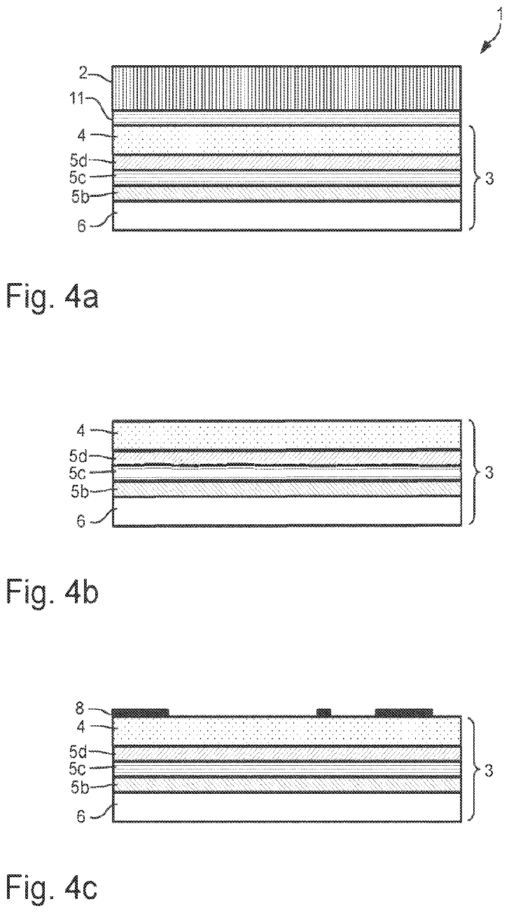

FIG. 4a to FIG. 4c schematically show sectional representations of a transfer film

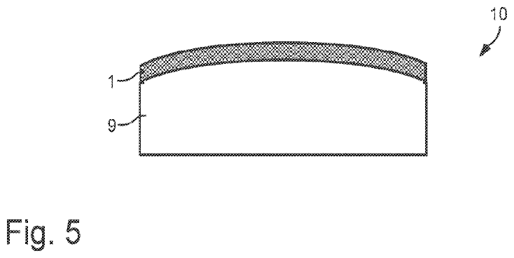

FIG. 5 schematically shows a sectional representation of a plastic article

FIG. 1a and FIG. 1b schematically show sectional representations of a transfer film 1. The transfer film 1 shown in FIG. 1a, in particular for application to a base body, comprises a carrier ply 2 and a transfer ply 3, wherein the transfer film has a first layer 4, in particular the surface of which can be touched by a person at least in areas after the application to the base body, and wherein the first layer 4 contains at least one substance with an antimicrobial action.

The transfer film 1 shown in FIG. 1a thus has a first layer 4 which contains at least one substance with an antimicrobial action. As shown in FIG. 1a, the transfer film 1 comprises a carrier ply 2 and a transfer ply 3, in particular wherein, as shown in FIG. 1a, the transfer ply 3 comprises the first layer 4.

Preferably, the transfer film 1 is in particular an in-mold decoration film (IMD film) or an insert-molding film (insert film). However, it is also possible for the transfer film to be a hot-stamping film and/or in-mold film, in particular an in-mold labeling film (IML film) and/or a print mold design film. It is particularly advantageous if the transfer film 1 is formable, in particular formable by means of injection molding and/or deep drawing.

As shown in FIG. 1a and FIG. 1b, the transfer ply 3 is detachable from the carrier ply 2. For this, the transfer film 1 expediently has a detachment layer, not shown in FIGS. 1a and 1b, in particular which is arranged between the carrier ply 2 and the detachable transfer ply 3.

Preferably, the detachment layer has a layer thickness of between 0.01 μm and 10 μm, preferably between 0.1 μm and 5 μm, and/or consists of waxes, polyethylene (PE), polypropylene (PP), cellulose derivatives and/or poly(organo)siloxanes.

The carrier ply 2 is preferably formed of ABS (=acrylonitrile butadiene styrene), ABS/PC, PET (=polyethylene terephthalate), PC (=polycarbonate), PMMA (=polymethyl methacrylate), PE (=polyethylene), PP (=polypropylene) and/or PPP (=polyether polycarbonate polyols). The layer thickness of the carrier ply 2 is advantageously between 5 μm and 500 μm, in particular between 6 μm and 100 μm. The carrier ply 2 shown in FIG. 1a is for example a carrier ply made of PET with a layer thickness of 50 μm.

The at least one substance with an antimicrobial action preferably is or comprises a heavy metal, preferably silver (Ag), further preferably colloidal silver (Ag(0)) and/or bound silver (Ag⁺). The transfer film shown in FIG. 1a contains, for example, bound silver (Ag⁺) as the at least one substance with an antimicrobial action in the first layer, in particular wherein Ag₂O—Ca_{α}Zn_{β}Al_{γ}(PO₄)₆ was used as bound silver here.

The percentage of the at least one substance with an antimicrobial action in the first layer 4 is preferably between 0.01% and 10%, preferably between 0.1% and 5%, further preferably between 1% and 2%. In the transfer film 1 shown in FIG. 1a, the percentage of the at least one substance with an antimicrobial action in the first layer 4 is for example 2%.

It is further preferred if, through the at least one substance with an antimicrobial action in the first layer 4, a color deviation ΔE of less than 3.0, preferably less than 1.0, further preferably less than 0.5, still further preferably less than 0.15, is produced. Thus, for example, through the at least one substance with an antimicrobial action in the first layer 4, in FIG. 1a, a color deviation ΔE of 0.05 is produced.

With respect to further possible designs of the first layer and/or the at least one substance with an antimicrobial action, reference is made here to the above statements.

It further advantageous that, through the at least one substance with an antimicrobial action, a mean log reduction R, in particular relative to a reference sample after 24 h, preferably in accordance with the standard ISO 22196, of at least 4, preferably of at least 5, further preferably between 4 and 8, still further preferably between 5 and 7, is achieved and/or that, through the at least one substance with an antimicrobial action, a mean log reduction R₀, in particular relative to a reference sample at the time 0, preferably in accordance with the standard ISO 22196, of at least 4, preferably of at least 6, further preferably between 4 and 7, is achieved. Thus, for example, through the transfer film 1 shown in FIG. 1a, a mean log reduction R of 7.0 and/or a mean log reduction R₀ of 6.3 is achieved.

With respect to the mean log reductions R and R₀ and the antimicrobial action, reference is also made here to the above statements.

The first layer 4 is advantageously a protective varnish layer, in particular protects in particular the layers lying underneath the first layer 4, in particular the protective varnish layer 4, seen from the viewpoint of a person, from mechanical, physical and/or chemical environmental influences. The first layer 4 preferably has a layer thickness of between 1 μm and 15 μm, preferably between 2 μm and 8 μm. The first layer 4 shown in FIG. 1a is for example a protective varnish layer 4 with a layer thickness of 5 μm.

With respect to further possible designs of the first layer 4 and/or the protective varnish layer 4, reference is made here to the above statements.

The first layer 4 shown in FIG. 1a is not yet completely cured at least in areas, with the result that the first layer 4 has not been and/or is not completely cured in particular until after the step of back-injection molding. It is therefore expedient that the first layer 4 is radiation-curable, in particular UV-curable. The first layer 4 shown in FIG. 1a is for example curable by means of UV radiation from the wavelength range between 100 nm and 380 nm, preferably between 200 nm and 380 nm, further preferably between 200 nm and 300 nm. The first layer 4 shown in FIG. 1a contains, for example, isocyanate groups and hydroxyl groups and/or melamine resins and hydroxyl groups here.

With respect to further possible designs of the first layer 4, in particular with regard to embodiments in which the first layer 4 is precurable chemically, thermally or by means of radiation, in particular by means of UV radiation, and, preferably after the step of back-injection molding, is completely curable chemically thermally or by means of radiation, in particular by means of UV radiation, reference is also made here to the above statements.

As shown in FIG. 1a, the transfer film 1, in particular the transfer ply 3, further comprises a decorative ply 5. The decorative ply 5 preferably has one or more, preferably opaque, translucent or transparent, colored varnish layers, replication varnish layers and/or metal layers.

It is useful here if the decorative ply 5 is single- or multi-ply. It thus possible, for example, for the decorative ply 5 to comprise one or more colored varnish layers, which are molded such that they form a decorative colored pattern or element when interacting.

It is further possible for the decorative ply 5 to be molded over the whole surface or in a pattern, for example in the form of alphanumeric characters or motifs. It is further expedient if the decorative ply 5 has further optically variable layers, for example with pigments, holograms, optical diffraction structures, lenses, prisms, thin-film layers or crosslinked liquid crystals. It is thus advantageous if the decorative ply 5 has at least one layer with a decorative effect.

The layer thickness of the decorative ply 5 is preferably between 0.5 μm and 100 μm, further preferably between 1 μm and 50 μm.

The decorative ply 5 shown in FIG. 1a is for example a single-ply decorative ply 5 with a layer thickness of 5 μm, which comprises a colored varnish layer for producing a decorative colored element.

The transfer ply 3 shown in FIG. 1a has a total layer thickness of 15 μm.

It further makes sense if the decorative ply 5 is designed such that a color deviation ΔE of the optical impression of the transfer film 1 brought about by the at least one substance with an antimicrobial action in the first layer 4 is compensated for, preferably by variation of the decorative ply 5, further preferably of the one or more, preferably opaque, translucent or transparent, colored varnish layers of the decorative ply 5.

It is preferred here that, during the compensation for the color deviation ΔE of the optical impression of the transfer film 1 brought about by the at least one substance with an antimicrobial action in the first layer 4, one or more of the following parameters of the decorative ply 5, in particular of the one or more, preferably opaque, translucent or transparent, colored varnish layers, replication varnish layers and/or metal layers of the decorative ply 5, are varied: layer thickness, pigmentation level, degree of color saturation, material composition, dispersion of the pigments (depending on the fineness of grinding of the pigments), type of dispersing additives, pigment composition, pigment mixture, pigment layer thickness, metal layer thickness, metal type.

It is thus preferred that the one or more parameters are varied between 0% and 50%, preferably between 2% and 30%, compared with parameters of a transfer film 1 without the at least one substance with an antimicrobial action in the first layer 4, in particular which achieves the desired the optical impression for the person.

Furthermore, as shown in FIG. 1a, the transfer film 1, in particular the transfer ply 3 of the transfer film 1, has a primer layer 6, in particular wherein the primer layer 6 forms the side of the transfer film 1 facing away from a person. It is thus expedient if the primer layer 6 is arranged on the side of the decorative ply 5 facing away from the carrier ply 2.

It further makes sense if the primer layer 6 is a layer made of polymers and/or copolymers, in particular comprising polyacrylates and/or acrylates, for example PMMA, polyester, PU or PVC. The primer layer 6 expediently has a layer thickness of between 0.1 μm and 50 μm, preferably between 0.5 μm and 7 μm, further preferably between 2.5 μm and 3.0 μm. Thus, the primer layer 6 shown in FIG. 1 is for example a layer made of polymers comprising PMMA with a layer thickness of 7 μm.

The transfer film 1 shown in FIG. 1a and/or the first layer 4 preferably has a haze value of between 20 and 40, preferably between 20 and 30, further preferably between 25 and 30, and further preferably has a milky-cloudy appearance. With respect to the haze value, the determination thereof and further designs of the transfer film relating to this, reference is made to the above statements.

The transfer film 1 shown in FIG. 1a, comprising a carrier ply 2, a transfer ply 3 and a first layer 4, wherein the surface of the first layer 4 can be touched by a person at least in areas after the application to a base body, and wherein the first layer 4 contains at least one substance with an antimicrobial action, is preferably produced by means of the following method steps:
providing the carrier ply 2;
applying the transfer ply 3 to the carrier ply 2, in particular by means of printing, casting, laminating or stamping, wherein the step of applying the transfer ply 3 to the carrier ply comprises the application of the first layer 4, in particular by means of printing.

It is further expedient here if the method further comprises the following step, in particular which is carried out between the step of providing the carrier ply 2 and the step of applying the transfer ply 3 to the carrier ply 2:
applying a detachment layer, preferably such that the detachment layer is arranged between the carrier ply 2 and the, in particular detachable, transfer ply 3.

It is further advantageous here if the step of applying the transfer ply 3 further comprises at least one of the following steps:
applying a decorative ply 5, in particular wherein the decorative ply 5 has one or more, preferably opaque, translucent or transparent, colored varnish layers, replication varnish layers and/or metal layers;
applying an adhesion-promoter layer, in particular such that the adhesion-promoter layer is arranged between the first layer and the decorative ply 5;
applying a primer layer 6, in particular such that the primer layer 6 forms the side of the transfer film 1 facing away from the person.

With respect to further designs of the method for producing a transfer film 1, reference is made here to the above statements.

The sectional representation shown in FIG. 1b corresponds to the sectional representation shown in FIG. 1a with the difference that the carrier ply 2 has been removed. With respect to the design of the layers 4, 5 and 6, reference is therefore made here to the above statements.

FIG. 2a and FIG. 2b schematically show sectional representations of transfer films 1. FIG. 2a thus schematically shows a sectional representation of a transfer film 1.

As shown in FIG. 2a, the transfer film 1 comprises a first layer 4, a carrier ply 2, a decorative ply 5 and a primer layer 6.

The transfer film shown in FIG. 2a corresponds to the transfer film 1 shown in FIG. 1a with the difference that the first layer 4, as shown in FIG. 2a, is arranged on the side of the carrier ply 2 facing away from the decorative ply 5, in particular the transfer ply 3. The first layer 4 is thus applied to the side of the carrier ply 2 facing away from the transfer ply 3. Furthermore, the transfer film 1 shown in FIG. 2a preferably does not have a detachment layer, with the result that the transfer ply 3, which comprises the decorative ply 3 and the primer layer 6, cannot be easily detached. However, it is also possible for the transfer film 2 shown in FIG. 2a nevertheless to have a detachment layer, which is preferably arranged between the carrier ply 2 and the transfer ply 3. In the case of the transfer film 1 shown in FIG. 2a, the carrier ply 2 thus has the first layer 4.

Both in the case of the transfer film shown in FIG. 1a and the one shown in FIG. 2a, in particular after the application of the transfer film 1 to a base body, the first layer 4 thus forms the layer facing a person, and thus the uppermost and/or outermost layer, in particular such that the surface of the first layer 4 can be touched by a person at least in areas. In the case of the transfer film 1 shown in FIG. 1a, this is achieved, as shown in FIG. 1b, by peeling off and/or detaching the carrier ply 2, and in the case of the transfer film 1 shown FIG. 2a, the carrier ply 2 remains with the first layer 4 located on it.

It further also possible, in the case of the transfer film 1 shown in FIG. 2a, for the carrier ply 2 itself, or additionally, to contain at least one substance with an antimicrobial action.

With respect to the further design of the layers 2, 4, 5 and 6 shown in FIG. 2a, which the transfer film 1 comprises, reference is made here to the above statements.

The transfer film 1 shown in FIG. 2b corresponds to the transfer film 1 shown in FIG. 2a with the difference that the transfer film 1 shown in FIG. 2b does not have a primer layer 6. The transfer film 1 shown in FIG. 2b has a carrier ply 2 preferably made of polycarbonate (PC) with a layer thickness of between 750 μm and 1000 μm. In the case of the transfer film 1 shown in FIG. 2b, it is further also possible for this further to have one or more functional layers, not shown in FIG. 2b. The one or more functional layers are advantageously arranged on the side of the decorative ply 5 facing away from the carrier ply 2. It is thus possible for the one or more functional layers to be arranged on the side of the transfer film 1 facing away from the person. The one or more functional layers are preferably electrical functional layers which further preferably comprises electrical components, such as sensors and/or illuminants.

In particular in the case of the transfer films 1 shown in FIG. 2a and FIG. 2b, the carrier ply 2 is also transferred onto the base body or the carrier ply 2 remains after application to the base body, with the result that the transfer film 1 is used here in the sense of a laminating film. In other words, it is possible for the transfer film 1 shown in FIG. 2a and FIG. 2b to be a laminating film.

FIG. 3a and FIG. 3b schematically show sectional representations of a transfer film 1.

The transfer film 1 shown in FIG. 3a comprises a carrier ply 2, a first layer 4, an adhesion-promoter layer 7, decorative plies 5 and 5a and a primer layer 6. As shown in FIG. 3a, the layers 4, 7, 5, 5a and 6 here form the transfer ply 3, which, as set out above, is preferably detachable from the carrier ply 2. It is possible here for the transfer film 1 further to have a detachment layer, which is in particular arranged between the carrier ply 2 and the first layer 4.

As already explained in the context of FIG. 1a, the first layer 4 is a layer the surface of which can be touched by a person at least in areas after the application to a base body and which further contains at least one substance with an antimicrobial action. It is further preferably a protective varnish layer 4. With respect to the design of the first layer 4 and/or the protective varnish layer 4 as well as the mode of action thereof, reference is made here to the above statements.

The adhesion-promoter layer 7 is, as shown in FIG. 3a, arranged between the first layer 4 and the decorative plies 5 and 5a. The adhesion-promoter layer 7 preferably has a layer thickness of between 0.1 μm and 100 μm, preferably between 0.5 μm and 50 μm, further preferably between 1 μm and 20 μm. It is advantageous here if the adhesion-promoter layer 7 is a layer made of PMMA, PVC, polyester, polyurethanes, acrylates, chlorinated polyolefins, polypropylene, epoxy resins, polyurethane polyols, inorganic fillers, these can be used crosslinked and/or uncrosslinked, wherein isocyanates, melamines, alcohols and aziridines can preferably be used as crosslinker component. The adhesion-promoter layer 7 shown in FIG. 3a is a layer made of acrylate, which has a layer thickness of 3 μm.

As shown in FIG. 3a, decorative ply 5 and 5a is a multi-ply decorative ply. The decorative ply 5 shown in FIG. 3a is for example an opaque colored varnish layer, which is applied in areas and forms a pattern, for example in the form of a symbol. It is also possible for the decorative ply 5 to be, for example, a metal layer molded in areas, for example made of aluminum, which likewise forms a pattern, for example in the form of alphanumeric characters. The decorative ply 5a is likewise a colored varnish layer, which formed for example over the whole surface and forms a background color for the decorative ply 5 formed in areas. However, it also possible for the decorative ply 5 to be transparent, with the result that, in this case too, the decorative ply 5a represents a background color and/or that the decorative ply 5a and the decorative ply 5 generate a mixed color for a person viewing.

With respect to the design of the further layers 2 and 4, reference is made here to the above statements.

It is further expedient if the transfer film 1 has an adhesion which has a characteristic value of GT 0 and/or 5B, preferably determined according to DIN EN ISO 2409:2013-06 (“Beschichtungsstoffe—Gitterschnittprüfung [Paints and varnishes—Cross-cut test] (ISO 2409:2013), German version of EN ISO 2409:2013”, issue date: 2013 June) and/or according to ASTM D3359-09 (“Standard Test Methods for Measuring Adhesion by Tape Test”, issue date: 2009), test method B.

The adhesion of the transfer film 1 was tested for example by means of a cross-cut test according to DIN EN ISO 2409: 2013-06.

In each case 6 cuts were made vertically and 6 cuts were made horizontally (at an angle of 90° to the vertical cuts) in the coating as far as the substrate with the aid of a blade and preferably with the aid of a template. The width of the cut was dependent on the layer thickness of the coating. In the case of coatings with a layer thickness of less than 60 μm, the distance between the cuts is preferably approximately 1 mm.

A clear adhesive tape or an adhesive crepe tape with an adhesiveness of from 6 N/25 mm to 10 N/25 mm was stuck to the resulting square of cuts (measurement area). This was peeled off in a time of from 0.5 to 1 second at an angle of 60°.

The evaluation was effected in accordance with DIN EN ISO 2409: 2013-06 by visual assessment of the measurement area and classification into cross-cut characteristic values of from 0 (very good adhesion) to 5 (very poor adhesion), abbreviated to GT 0 to GT 5, or in accordance with ASTM D 3359-09, test method B.

The sectional representation shown in FIG. 3b corresponds to the sectional representation shown in FIG. 3a with the difference that the carrier ply 2 has been removed. With respect to the design of the layers 4, 7, 5, 5a and 6, reference is therefore made here to the above statements.

FIG. 4a to FIG. 4c schematically show sectional representations of a transfer film 1. FIG. 4a thus schematically shows a sectional representation of a transfer film 1.

The transfer film 1 shown in FIG. 4a comprises a carrier ply 2, a detachment layer 11, a first layer 4, decorative plies 5b, 5c and 5d and a primer layer 6.

The transfer film 1 shown in FIG. 4a is an in-mold decoration film (IMD film) or an insert-molding film (insert film). The first layer 4 here contains at least one substance with an antimicrobial action. The first layer 4 further forms the outermost and/or uppermost layer, in particular after the application to a base body. In other words, it is possible for the first layer 4 to form the outside, in particular which is accessible to a person, in an injection-molded article decorated with the transfer film and after the carrier ply 2 has been peeled off.

As shown in FIG. 4a, the transfer film 1 comprises a carrier ply 2 and a transfer ply 3, wherein the transfer ply, as shown in FIG. 4, comprises the layers 8, 4, 5d, 5c, 5b and 6 here.

The transfer film 1 shown in FIG. 4a has a carrier ply 2 made of PET (=polyethylene terephthalate) with a layer thickness of 50 μm, a detachment layer 3 made of a polyethylene wax (melting range 80° C. to 100° C.) arranged on the carrier ply 2, and a transfer ply 3 arranged on the side of the detachment layer 3 facing away from the carrier ply 2, wherein the transfer ply in particular forms a decorative element for decorating a base body and/or an injection-molded article, and wherein the decorative element has several layers.

As shown in FIG. 4a, the transfer ply 3 has a first layer 4 adjoining the detachment layer 11. As set out above, the first layer 4 here comprises at least one substance with an antimicrobial action. The first layer 4 shown in FIG. 4 is further a protective varnish layer 4, which has a layer thickness of between 2 μm and 5 μm. The protective varnish layer 4 here is, for example, a so-called “dual-cure system” based on a hydroxyl-containing polyacrylic acrylate crosslinked with melamine resin. The protective varnish layer 4 therefore has, for example, the following composition, wherein the numerical values are data in percent by weight relative to the liquid varnish:

| | |
|---|---|
| Melamine formaldehyde resin | 0.1-1.5 |
| Catalyst | 0.1-1.5 |
| Ethanol | 15-20 |
| Diacetone alcohol | 15-20 |
| Hydroxyl-containing polyacrylic | 20-30 |
| acrylate, 60% | |
| Polyacrylic acrylate | 4-6 |
| Amorphous silica | 2-5 |
| Cyclohexanone | 10-20 |
| Methyl ethyl ketone | 10-12 |
| Photoinitiator | 0.1-1 |

The first layer 4 and/or the protective varnish layer 4 here contains 0.28% colloidal silver (Ag(0)) as the at least one substance with an antimicrobial action. This value is in particular relative to the solids (FSK), i.e. the dried protective varnish layer. In other words, relative to the solids (FSK) means that the proportion of the at least one substance with an antimicrobial action, thus here in particular colloidal silver (Ag(0)), is only determined when the first layer 4 and/or the protective varnish layer has been dried. For the first layer 4 shown in FIG. 4a and/or the protective varnish layer 4, in particular 0.05 kg of a 50% (colloidal) silver solution was added to 41.12 kg protective varnish, i.e. 0.025 kg of a 100% silver solution was added to 41.12 kg protective varnish. The protective varnish has an FSK of 21.45% for example, with the result that 41.12 kg weighed 8.8 kg after drying. This 8.8 kg contains in particular the above-named 0.025 kg silver and/or colloidal silver (Ag(0)), with the result that the percentage of the at least one substance with an antimicrobial action, here in particular silver and/or colloidal silver (Ag(0)), is consequently 0.28% here, in particular in the FSK. It is further possible to extend this formulation by 0.1% to 0.25% of a 50% (colloidal) silver solution. For the transfer film 1 shown in FIG. 4a, this protective varnish was printed with an application weight of 3-4 g/m² and thermally dried.

As shown in FIG. 4a, the decorative plies 5d, 5c and 5b, which are for example colored varnish layers, are arranged adjoining the protective varnish layer 4 provided with at least one substance with an antimicrobial action on the side of the protective varnish layer 4 provided with the at least one substance with an antimicrobial action facing away from the carrier ply 2. In turn, a primer layer 6 made of PVC copolymers and PMMA (MW 60,000 g/mol) on (PVC=polyvinyl chloride, PMMA=polymethyl methacrylate, MW=molecular weight) is arranged adjoining the decorative plies 5d, 5c and 5b on the side of the decorative plies 5d, 5c and 5b facing away from the carrier ply 2.

The transfer film 1 shown in FIG. 4a is suitable for use in an IMD method for producing a decorated injection-molded article. It is therefore further advantageous if the transfer film 1 is (thermo-)formable, in particular (thermo-)formable by means of injection molding and/or deep drawing.

FIG. 4b shows the transfer film 1 shown in FIG. 4a, wherein the carrier ply 2 and the detachment layer 11 have been removed, i.e. FIG. 4b shows the transfer film 1 in particular after the application to a base body, which is not represented in FIG. 4b, however. As shown in FIG. 4b, the protective varnish layer 4 therefore now forms the outermost and/or uppermost layer. In other words, the protective varnish layer 4 forms the outside, which is accessible to a person, in a plastic article decorated with the transfer film and after the carrier ply 2 has been peeled off.

FIG. 4c shows the transfer film 1 shown FIG. 4b, likewise after the application to a base body, wherein an overprint varnish 8, i.e. an overprintable varnish layer 8, has been applied to the protective varnish layer 4 in a further step. As can be seen in FIG. 4a to FIG. 4c, the overprint varnish 8 is preferably not applied, for example, to the plastic article decorated with the transfer film 1 until after the carrier ply 2 has been peeled off. The overprint varnish 8 is, as shown in FIG. 4c, applied to the protective varnish layer 4 partially or in areas and further arranged on the side facing the person.

Because the overprint varnish 8 is applied partially, the protective varnish layer 4 can furthermore be touched by a person at least in areas, and can therefore furthermore have an antimicrobial action.

The overprint varnish 8 is for example applied as a further layer by means of digital printing and/or pad printing. The overprint varnish 8 is advantageously a printed layer, in particular which is designed patterned for the molding of alphanumeric characters, patterns and/or symbols. The patterned overprint varnish 8 can in particular be arranged in register relative to further patterned elements of the decorative plies 5d, 5c and 5b.

FIG. 5 schematically shows a sectional representation of a plastic article 11.

The plastic article 10 shown in FIG. 5 comprises a base body 9 formed of a plastic injection-molding compound, and a transfer film 1, wherein the transfer film 1 be designed as set out above. In particular, it is possible here for the transfer film 1 to be designed, for example, in accordance with the transfer film 1 according to one of FIG. 1a, 1b, FIG. 2a, FIG. 2b, FIG. 3a, 3b or of FIG. 4a to FIG. 4c. It further possible for the carrier ply 2, as shown in FIG. 1b, FIG. 3b, FIG. 4b and FIG. 4c, to be peeled off or for the carrier ply 2, as shown in FIG. 1a, FIG. 2a, FIG. 2b, FIG. 3b and FIG. 4a, still to be present and/or not to be peeled off until later.

The plastic article 10 shown in FIG. 5 thus comprises a base body 9 formed of a plastic injection-molding compound, and a first layer 4, wherein the first layer 4 can be touched by a person at least in areas, in particular after the carrier ply 2 has been peeled off, and contains at least one substance with an antimicrobial action. It is also possible here for the first layer 4 to be a protective varnish layer, as set out above.

It is furthermore possible for the plastic article 10 further to have at least one of the following layers:
a decorative ply 5, wherein the decorative ply 5 preferably has one or more, preferably opaque, translucent or transparent, colored varnish layers 5a, 5b, 5c, 5d, replication varnish layers and/or metal layers and wherein the decorative ply is further preferably arranged between the first layer 4 and the base body 9;
a primer layer 6, in particular wherein the primer layer 6 is arranged between the first layer 4 and the base body 9 and/or between the decorative ply 5 and the base body 9;
an adhesion-promoter layer 7, in particular wherein the adhesion-promoter layer 7 is arranged between the first layer 4 and the decorative ply 5;
a, preferably detachable, carrier ply 2, in particular wherein the carrier ply is arranged on the side of the first layer 4 facing away from the base body 9 or wherein the carrier ply 2 is arranged between first layer 4 and the base body 9.

With respect to further possible designs of these layers, reference is made here to the above statements.

Such a plastic article 10 is preferably produced with a method for decorating a plastic article 10, wherein the method comprises the following steps, which are in particular performed in the following order:
providing a transfer film 1 comprising a carrier ply 2, a transfer ply 3 and a first layer 4, wherein the surface of the first layer 4 can be touched by a person at least in areas after the application to the base body 9, and wherein the first layer contains at least one substance with an antimicrobial action;
arranging the transfer film 1 in an injection mold;
back-injection molding the transfer film 1 arranged in the injection mold with the plastic injection-molding compound such that the base body 9 is formed by the plastic injection-molding compound and the base body 9 joins to the transfer film 1;
optionally removing the carrier ply 2 from the decorated plastic article 10;
optionally taking the decorated plastic article 10 out of the injection mold.

It is further preferred if, in particular the after the step of back-injection molding the transfer film 1 arranged in the injection mold with the plastic injection-molding compound, the following step is further carried out:
peeling the carrier ply 2 off the transfer film 3.

It is furthermore possible, as set out in connection with FIG. 4a to FIG. 4c, to apply an overprint varnish layer to the first layer 4, in particular after the carrier ply 2 has been peeled off.

With respect to further possible designs of the plastic article 10 and the method for decorating a plastic article 10, reference is made here to the above statements.

### LIST OF REFERENCE NUMBERS

1 transfer film
2 carrier ply
3 transfer ply
4 first layer, protective varnish layer
5 decorative ply
5a, 5b, 5c, 5d colored varnish layers
6 primer layer
7 adhesion-promoter layer
8 overprint varnish
9 base body
10 plastic article
11 detachment layer

1. A transfer film for application to a base body and comprising a carrier ply and a transfer ply, wherein
the transfer film has a first layer the surface of which can be touched by a person at least in areas after the application to the base body, and wherein the first layer contains at least one substance with an antimicrobial action.

2-4. (canceled)

5. The transfer film according to claim 1, wherein
the at least one substance with an antimicrobial action is or comprises a heavy metal.

6. The transfer film according to claim 1, wherein
the percentage of the at least one substance with an antimicrobial action in the first layer is between 0.01% and 10%.

7. The transfer film according to claim 1, wherein
through the at least one substance with an antimicrobial action, a mean log reduction R, of at least 4, is achieved and/or wherein, through the at least one substance with an antimicrobial action, a mean log reduction R₀, of at least 4, is achieved.

8-9. (canceled)

10. The transfer film according to claim 1, wherein
the first layer is a protective varnish layer and/or which contains isocyanate groups having hydroxyl groups, melamine resins having hydroxyl groups, polyisocyanates having hydroxyl-containing polymers or melamine resins having hydroxyl-containing polymers.

11. The transfer film according to claim 1, wherein
through the at least one substance with an antimicrobial action in the first layer, a color deviation ΔE of less than 3.0, is produced.

12. The transfer film according to claim 1, wherein
the transfer ply has a decorative ply.

13. The transfer film according to claim 12, wherein
the decorative ply is designed such that a color deviation ΔE of the optical impression of the transfer film brought about by the at least one substance with an antimicrobial action in the first layer is compensated for.

14. The transfer film according to claim 13, wherein
during the compensation for the color deviation ΔE of the optical impression of the transfer film brought about by the at least one substance with an antimicrobial action in the first layer, one or more of the following parameters of the decorative ply are varied: layer thickness, pigmentation level, degree of color saturation, material composition, dispersion of the pigments (depending on the fineness of grinding of the pigments), type of dispersing additives, pigment composition, pigment mixture, pigment layer thickness, metal layer thickness, metal type.

15-19. (canceled)

20. A method for producing a transfer film, comprising a carrier ply, a transfer ply and a first layer, wherein the surface of the first layer can be touched by a person at least in areas after the application to a base body, wherein the first layer contains at least one substance with an antimicrobial action, and wherein the method comprises the following steps:
providing the carrier ply;
applying the first layer to the carrier ply;
applying the transfer ply to the carrier ply and/or the first layer.

21. The method according to claim 20, wherein
the method further comprises the following step:
mixing the at least one substance with an antimicrobial action into the starting material of the first layer.

22. (canceled)

23. The method according to claim 20, wherein
the method further comprises the following step:
dispersing the at least one substance with an antimicrobial action.

24. (canceled)

25. The method according to claim 20, wherein
the method further comprises the following step:
adapting a decorative ply such that the color deviation ΔE of the optical impression of the transfer film brought about by the at least one substance with an antimicrobial action in the first layer is compensated for.

26. (canceled)

27. A method for decorating a plastic article with a base body formed of a plastic injection-molding compound comprising the following steps:
providing a transfer film comprising a carrier ply, a transfer ply and a first layer, wherein the surface of the first layer can be touched by a person at least in areas after the application to the base body, and wherein the first layer contains at least one substance with an antimicrobial action;
arranging the transfer film in an injection mold;
back-injection molding the transfer film arranged in the injection mold with the plastic injection-molding compound such that the base body is formed by the plastic injection-molding compound and the base body joins to the transfer film.

28-29. (canceled)

30. A plastic article comprising a base body formed of a plastic injection-molding compound, and a first layer, wherein the first layer can be touched by a person at least in areas and contains at least one substance with an antimicrobial action.

31. The plastic article according to claim 30, wherein
the plastic article further has at least one of the following layers:
a decorative ply;
a primer layer;
an adhesion promoter layer;
a carrier ply.

32. (canceled)
